(19) United States
(12) Patent Application Publication
(10) Pub. No.: US 2018/0109678 A1
(43) Pub. Date: Apr. 19, 2018

(54) PREDICTIVE VOICE-BASED CUSTOMER SUPPORT

(71) Applicant: CA, Inc., New York, NY (US)

(72) Inventor: Suresh Sharma, Rajasthan (IN)

(21) Appl. No.: 15/295,150

(22) Filed: Oct. 17, 2016

(51) Int. Cl. H04M 3/51; H04M 3/523; H04L 29/08

(52) U.S. Cl. CPC H04M 3/5191; H04L 67/22; H04M 3/5166; H04M 3/5235

(57) ABSTRACT

A process and corresponding system provide customer support services by receiving a support request from a user and analyzing context information in response to the support request. Customer support services are further provided by predicting a customer need based on the analyzed context information, and selecting a proper customer support representative device based on the predicted customer need. In response thereto, customer support services are further provided by transmitting automatically, from a server computer to a voice communication system, a request to initiate a voice-based connection between the user and a selected customer support representative.

### BACKGROUND

### Field of the Disclosure

The present disclosure relates generally to computer systems and computer-implemented processes that implement predictive voice-based customer support.

### Description of Related Art

Many companies have telephone or voice-based customer service processes for addressing various customer needs. Many of these processes use Interactive Voice Response (IVR) systems where customers cascade through a variety of menus using either a dual-tone-multi-frequency (DTMF) numeric keypad input or simple voice command inputs before connecting the customer to an appropriate service representative. Unfortunately, navigating through the IVR system is time-consuming and often frustrating for the customer.

### BRIEF SUMMARY

According to various aspects of the present disclosure, systems and computer-implemented processes provide customer support, for example, in a call center environment. Some embodiments comprise receiving a support request, analyzing context information in response to the support request, predicting a customer need based on the analyzed context information, and identifying a proper customer support representative based on the predicted customer need.

For instance, according to an aspect of the present disclosure, a computer-implemented process is provided. The computer-implemented process comprises receiving, at a server computer, a support request for voice-based customer support over a digital network, from a user interacting with a client device. The computer-implemented process also comprises retrieving context information in response to receiving the support request, and analyzing the retrieved context information. The computer-implemented process still further comprises predicting an anticipated voice-based customer query based on the analyzed context information, and selecting a customer support representative device based on the predicted customer query. Yet further, the computer-implemented process comprises transmitting automatically, from the server computer to a voice communication system, a request to initiate a voice-based connection between a communication device of the user and the selected customer support representative device.

According to another aspect of the present disclosure, a server computer comprises a receiver, computer-readable hardware, a processor, and a transmitter. The receiver is communicatively coupled to a digital network, and is configured to receive a support request for voice-based customer support over the digital network. The computer-readable hardware memory comprises context information. The processor is programmed to retrieve the context information from the computer-readable hardware memory in response to the received support request, analyze the retrieved context information, and predict an anticipated voice-based customer query based on the analyzed context information. The processor is further programmed to select a customer support representative device based on the predicted customer query, and generate a request to initiate a voice-based connection between a communication device of the user and the selected customer support representative device. The transmitter is communicatively coupled to a voice communication system, and is configured to transmit the generated request to the voice communication system.

According to yet another aspect of the present disclosure, computer-readable hardware is provided. The computer-readable hardware comprises program code stored thereon, wherein the program code is executable to perform receiving, at a server computer, a support request for voice-based customer support over a digital network, from a user interacting with a client device, and retrieving context information in response to receiving the support request. The program code is further executable to perform analyzing the retrieved context information, and predicting an anticipated voice-based customer query based on the analyzed context information. Still further, the program code is executable to perform selecting a customer support representative device based on the predicted customer query, and transmitting automatically, from the server computer to a voice communication system, a request to initiate a voice-based connection between a communication device of the user and the selected customer support representative device.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

FIG. 1 is a flowchart showing one embodiment of a process in which context information is stored during a user session.

FIG. 2 is a flowchart showing one embodiment of a process for providing predictive voice-based customer support.

FIG. 3 is a diagram showing one embodiment of an environment that supports the predictive voice-based customer support of FIG. 2.

FIG. 4 is a process flow diagram showing one embodiment of a process that is implemented in the environment of FIG. 3.

FIG. 5 is a schematic of a computer system comprising computer readable program code for executing the processes described herein.

### DETAILED DESCRIPTION

Many companies provide telephone or voice-based customer support. Often, these companies use Interactive Voice Response (IVR) systems during telephone-based support calls, so as to direct customers to an appropriate customer support representative. Typically, a customer cascades through a variety of menus in an IVR system using either dual-tone-multi-frequency (DTMF) inputs or simple voice commands, thereby identifying the particular reason for the customer support call. Unfortunately, sequentially advancing through an IVR system is both time-consuming and often frustrating for the customer.

In order to ameliorate this time-consuming process, the present disclosure provides an unconventional computer-implemented process for initiating a voice-based connection between a user and a selected customer support representative. To carry out the computer-implemented process, computer code is provided, which when executed, implements a specific feature, e.g., a user-selectable icon, which can be selected by a user interacting with a client device, in order to request customer support. In practical applications, this feature, e.g., user-selectable icon, can appear in a display area rendered by a browser application, as a link on an Internet web page, as an input keypress or combination of keypresses, or in another suitable form that can be detected and recognized by the user etc. If a user, e.g., a customer, wishes to speak with a customer support representative, then the user interacts with the feature, e.g., by selecting the designated icon in the above-example. Upon selection of the icon, the user's client device, e.g., computer, tablet, smartphone, etc., transmits to an application server, a request for a telephone call with a customer support representative. The request can also include other optional information, such as a contact phone number. Examples of the request are set out in greater detail herein.

The application server receives the request (e.g., along with the contact information for the customer if not already available to the application server) and, in response to the request, retrieves “context data”. Examples of context data include the current page from which the request was initiated, other pages visited by the user prior to initiation of the request, the sequence in which the prior pages were visited by the user, and possibly other contextual information. In an example implementation of a web-based environment, the context data is stored as the user navigated through the various page(s). The application server analyzes the retrieved context data to determine the context from which the user initiated the request for the telephone call. Based on the analyzed context data, the application server predicts an anticipated voice-based customer query of interest to the user. As an example, the predicted customer query can be related to a customer need.

The application server also determines an appropriate customer support representative that can address the user's predicted customer query and selects a corresponding customer support representative device associated with the determined customer support representative. Thereafter, the application server transmits a request to an electronic call manager that triggers an electronic workflow to initiate a voice-based connection between a communication device of the user and the selected customer support representative device, hence automatically facilitating a telephone call between the user and the customer support representative determined to be able to address the user's predicted customer query. Here, the communication device of the user can be a telephone associated with a contact phone number provided as part of the received support request. The communication device of the user can alternatively be a telephone associated with a contact phone number that is stored in memory associated with the application server or is otherwise discoverable by the application server. The communication device can be same as the client device, e.g., where the client device is a smart phone or other device with telephony capability. Alternatively, the user communication device can be a different physical device from the client device, e.g., where the client device is a computer, laptop, or other device without telephony capability.

Predicting the customer query, e.g., reason, need, etc., for a customer support call obviates the need for DTMF or voice input from the customer prior to being connected with an appropriate customer support representative.

Having provided a general description of a broad embodiment of the present disclosure, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

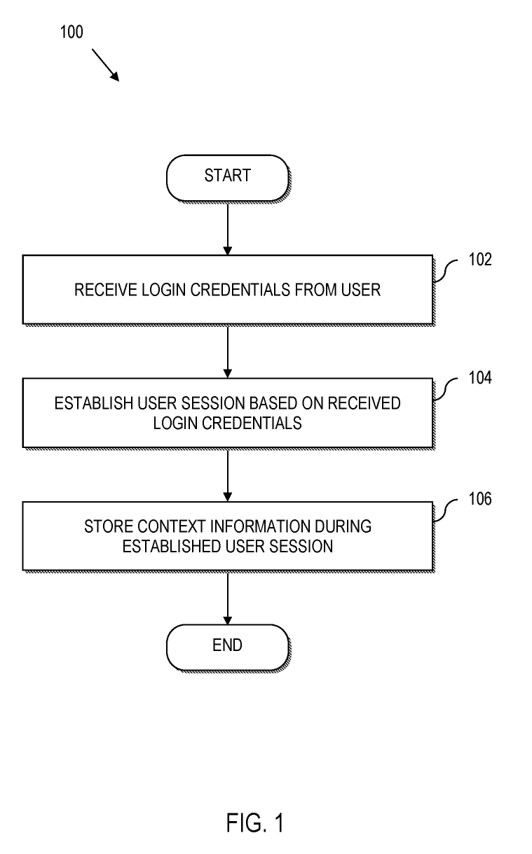

Referring now to FIG. 1, a flowchart illustrates an embodiment of a computer-implemented process 100 in which context information is stored during a user session. The computer-implemented process 100 may be carried out, for instance, as computer-readable hardware (e.g., computer-readable hardware memory, computer readable storage media, etc.) comprising computer instructions that instruct a processor to implement the described computer-implemented process. In this regard, the flowchart outlines an algorithm that is executed by the processor.

The computer-implemented process begins by receiving at 102, login credentials from a user. As will be described in greater detail herein, in an example implementation, the login credentials are received by an application server executing in, or otherwise linked to a call center environment. For instance, a manufacturer of a product can utilize a server computer to provide a customer portal that provides product information such as downloadable updates, warranty information, user manuals, service manuals, etc. A customer of the manufacturer in need of support with regard to a purchased product can thus log into the customer portal using a client device, e.g., personal computer, laptop, tablet, smart phone, etc., such as by providing a user name and a password.

As additional examples, there are many instances where a user must provide login credentials to access online environments for which assistance by customer support representatives is available. These include online shopping websites, online communications websites, online social media websites, etc. In each of these examples, a server eventually receives login credentials from the user, and establishes a user session (e.g., for shopping, searching, email, social interaction, etc.).

Based on the received login credentials, the computer-implemented process next establishes at 104, a user session. During the established user session, the computer-implemented process stores at 106, collected context information. In an example implementation, the server tracks the user's online activity (e.g., browser navigation, links clicked, time spent on certain website pages, etc., text or other keystrokes entered, metadata, environmental data, other discoverable information, etc., which may be indicative of user behavior, need, or other interest) for purposes of conducting analytics. The server further stores the tracked context information in a data storage device accessible by the application server.

For some embodiments, the context information is collected by implementing a hyper-text transfer protocol (HTTP) filter on an application server, which intercepts requests that are received at the server. The filter extracts information, such as a request universal resource locator (URL), session information, request parameters, other available information, combinations thereof, etc. from the HTTP request (e.g., an HTTP Request object).

In some embodiments, the server extracts the necessary information, such as from the request (e.g., HTTP Request object, etc.). As such, no information is required to be extracted local to the client device. For instance, in some embodiments, it becomes unnecessary for the client device to extract information locally. HTTP filters or servlet filters (and other similar concepts) are available for many server-side programming languages. Consequently, the filter is not restrictive to a particular programming language. Because the information is obtained as part of each request that is sent to the server, no batch processing is required.

For instance, in an example implementation, the context information includes one or more of logged in user information such as a date and time of login, a type of device from which the user logs in, a browsing history of the user, web form data, etc. An additional example of context information in addition to or in lieu of the above, includes a particular navigation sequence of visited pages. For other embodiments, context information includes (in addition to or in lieu of the above) other attributes, such as request parameter(s), response code(s), user's previous transaction history, error code(s), other available information, combinations thereof, etc. Regardless of the specific type of context information, the stored context information can provide the starting point for providing predictive voice-based customer support.

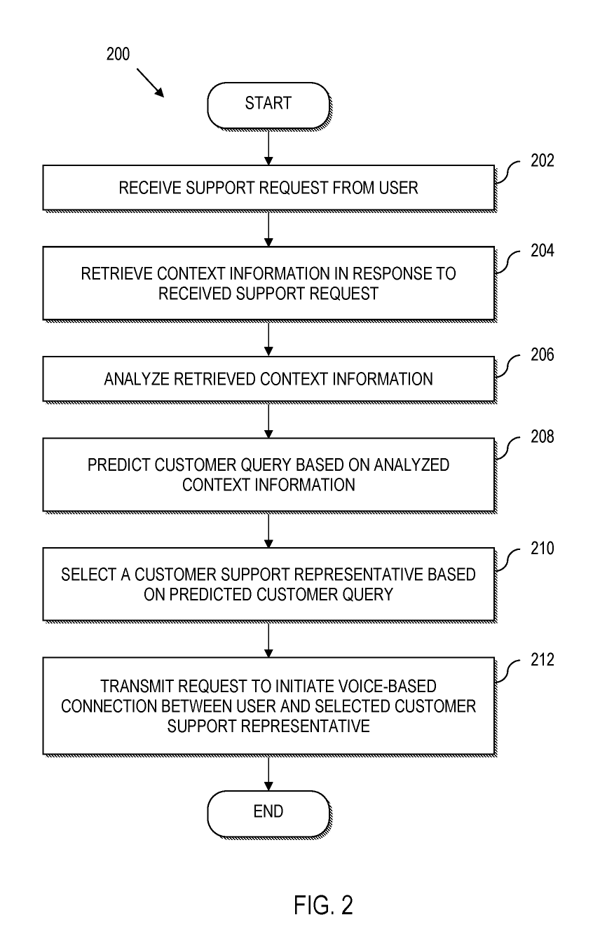

FIG. 2 is a flowchart showing an embodiment of a computer-implemented process 200 that provides predictive voice-based customer support. The computer-implemented process 200 may be carried out, for instance, as computer-readable hardware (e.g., computer-readable hardware memory, computer readable storage media, etc.) comprising computer instructions that instruct a processor to implement the described computer-implemented process. In this regard, the flowchart outlines an algorithm that is executed by the processor.

Referring to FIG. 2, the computer-implemented process 200 begins by receiving at 202, at a server computer (e.g., the application server in the above examples), a support request for voice-based customer support over a digital network, from a user interacting with a client device. Recalling from FIG. 1, in an example embodiment, the user has already established a user session at 104 and, thus, the user is already interacting with a client device that is in data communication with the server over a digital network when the support request is received by the server at 202. In other embodiments, a previously established user session is not required.

For some embodiments, the request is received by the server when the user selects a user-selectable feature, e.g., an icon for customer support, such as, for example, from a link displayed in a display screen by a browser executed by the client device as described more fully herein. As another illustrative example, the request is received by the server when the user selects a user-selectable icon displayed in a display screen in response to the execution of an application on a hand-held device.

The computer-implemented process continues by retrieving at 204, context information in response to receiving the support request. In an example implementation, the server retrieves the context information at 204, which was stored (see for example, 106 of FIG. 1) during the established user session (see for example, 104 of FIG. 1). As noted herein, the retrieved context information can comprise a date and time when the user session was established, a device type of the client device, a browsing history, a navigation sequence of visited pages, additional discoverable information, electronic information that is indicative of the online behavior of the user, any combination thereof, etc. By way of example, if a user is on an online shopping website to purchase a computer, then the browsing history may show that the user first logged into the shopping website, searched for computers, thereafter clicked on a link to a list of laptop computers, selected one of the choices for laptop computers, spent five (5) seconds on the page for that particular choice, went back to the list, selected another laptop choice, spent twenty (20) minutes on that page, etc.

The context information for a particular user session can provide a wealth of useful information. Notably however, this context information is gathered as part of an unconventional customer support/call center environment for instance, because such data is collected before there is any indication that the user may ultimately need customer support. That is, the computer-implemented process is not reactive to a user initiating a voice-based connection to a call center. Rather, the computer-implemented process is actively gathering and storing information that can be used in a current or future user encounter.

Once the context information is retrieved, the computer-implemented process continues by analyzing at 206, the retrieved context information. In an example implementation, the server analyzes the context information. Approaches for analyzing the retrieved context information sometimes depend on website design. Consequently, for some embodiments, context information is analyzed using a sequence of requested universal resource locators (URLs), request/session parameters, and optionally other information, e.g., which can be obtained from a user interface (UI). For example, if the last five (5) requested URLs are related to a particular UI action (e.g., a UI wizard), then the sequence of URLs provides useful information to analyze user context; if two UI actions (e.g., wizards) progress through the same URL sequence, then the request parameters can provide additional information with reference to the user and/or user actions.

For other embodiments, a previous transaction history is used to analyze data. For example, if a user has purchased a product but it has not shipped within an expected delivery time-window, then there is a likelihood that the user is calling about the status of the delivery.

The computer-implemented process continues by predicting at 208, an anticipated voice-based customer query based on the analyzed context information. For instance, the prediction of an anticipated voice-based customer query can be carried out by the server.

By way of example, and as noted more fully herein, examples of predicting an anticipated voice-based customer query can comprise performing at least one of looking up a predetermined list containing entries corresponding to customer needs; determining the anticipated voice-based customer query based upon a request uniform resource locator pattern; determining the anticipated voice-based customer query based upon a response code; and determining the anticipated voice-based customer query based upon a functionality mapping. Examples of predicting an anticipated voice-based customer query can further comprise matching at least one of a navigation sequence of visited pages in the browsing history of the user, at least one request parameter; a user's transaction history; and at least one response and/or error code, to an entry associated with a predicted customer need in the predetermined list.

Continuing with the online shopping example, the analysis at 206 includes analyzing the navigation sequence of visited pages in a browsing history. Thus, for example, if the navigation sequence shows that the user has gone back-and-forth between two (2) specific laptop computers, then the server may predict at 208 that the user has questions about those particular laptop computers. Alternatively, if the user is on a payment page, then the server may predict 208 that the user has questions about payment options. In some embodiments, predicting at 208, the anticipated voice-based customer query includes looking up a predetermined list indicative of possible customer needs (e.g., customer needs help selecting a computer, customer needs help paying online, customer needs help returning an item, etc.). This predetermined list need not be static but, for some embodiments, is derivable based on a request URL pattern or other request pattern, response code, functionality mapping, other data that can be parsed, or any combination thereof.

For such embodiments, the computer-implemented process further comprises matching certain of the context information, e.g., the browsing history or navigation sequence, to one of the entries (e.g., customer needs) in the list. In a further example, the computer-implemented process can utilize nested, sequential, hierarchical, event-driven, combinations thereof, etc., lists, each successive list narrowing to a more specific predicted customer query. For instance, keeping with the above example, since the user viewed pages on two specific laptop models, the computer implemented process can identify queries that are specific to one or both of the user-viewed laptops.

Although additional examples may be numerous, in an example, an appropriate prediction algorithm is fashioned depending on the business domain and the website design. For example, for some embodiments, the process analyzes the requested URLs and, if the last few URLs are a part of a specific wizard or process flow, then the process predicts that the user has some issues relating to the wizard or process functionality. In other embodiments, if a user attempts to perform the same or similar action numerous times, for which error codes are generated (e.g., an error code is generated as part of a request response), then the process predicts that the user is intending to notify an appropriate entity about the error and/or seeks information about the error codes and needs assistance. As an example, the user can seek to understand the related functionality associated with the action(s). For other embodiments, if the user accesses online help or troubleshooting guides related to a particular functionality (for which the user may be navigating through related web pages), then the process predicts that the user wants to know more details about the functionality. For instance, if the sequence of URLs relate to the same troubleshooting issue, then the process associates that troubleshooting issue with the user's needs.

Continuing with FIG. 2, the computer-implemented process continues by selecting at 210, a customer support representative device based on the predicted customer query. In an example implementation, based on the predicted customer query, the server identifies/determines a customer support representative likely to be able to address the predicted customer query, and selects a customer support representative device associated with the identified/determined customer support representative. Using the online shopping example, if the server predicts at 208 that the customer query relates to technical specifications, troubleshooting, or another technical issue, then the server identifies a representative from technical support as the customer support representative, and selects at 210, a customer support device associated with the identified representative from technical support. This process can be further refined. For instance, where the context information shows that the user viewed the web pages for two laptops, the selection of a technical support specialist can be further narrowed to a technical support specialist with expertise in one or both viewed laptops. As such, the server can interact with databases of a call center to evaluate skills, experience, availability, work queue, etc.

Keeping with the shopping example, to show additional examples, if the server predicts at 208 that the customer query relates to sales, then the server identifies a sales representative as the customer support representative, and selects at 210, a customer support representative device associated with the identified sales representative; if the server predicts at 208 that the customer query relates to payment, then the server identifies a billing specialist as the customer support representative, and selects at 210, a customer support representative device associated with the identified billing specialist; if the server predicts at 208 that the customer query relates to returns, then the server identifies a representative from shipping as the customer support representative, and selects at 210, a customer support representative device associated with the representative from shipping; and so on. In other words, the server selects at 210, a device associated with an appropriate customer support representative based on the analysis 206 and prediction 208.

Upon selecting at 210 the appropriate customer support representative device, the computer-implemented process continues by transmitting automatically, from the server computer to a voice communication system, a request to initiate a voice-based connection between a communication device of the user and the selected customer support representative device. In an example implementation, the server automatically transmits a request at 212 to a voice communication system (e.g., electronic telephone call manager, video conference server, etc.), which requests initiation of a voice-based connection (e.g., telephone call, video conference, etc.) between the user and the appropriate customer support representative. As an example, the server triggers the voice communication system to initiate a telephone call between a communication device (e.g., telephone, smart phone, etc.) of the user (where the telephone number is provided as part of the support request or otherwise available to the server), and the customer support representative device selected at 210. Notably, in some embodiments, the user need not take any further actions to contact the customer support representative, because the voice communication system interacts with the customer support representative device to call the communication device of the user.

For some embodiments, in conjunction with the transmission of the request at 212, the server also forwards some or all of the context information retrieved at 204 to the customer support representative associated with the customer support representative device selected 210 so that the representative is aware of the context in which the support request 202 was initiated. In certain embodiments, the context information analyzed at 206 is used to generate a summary of the navigation or browsing history of the user, thereby permitting the support representative to quickly discern the proper context of the customer query.

As shown from the computer-implemented process 200 of FIG. 2, because the appropriate customer support representative is paired with the user, and because in some embodiments the representative has at least a portion of the context information of the user (e.g., full browsing history, navigation sequence, summary, etc., or any combination thereof), the computer-implemented process 200 reduces delays and frustrations that are normally associated with a customer advancing sequentially through an IVR system before being connected to a voice-based customer support representative.

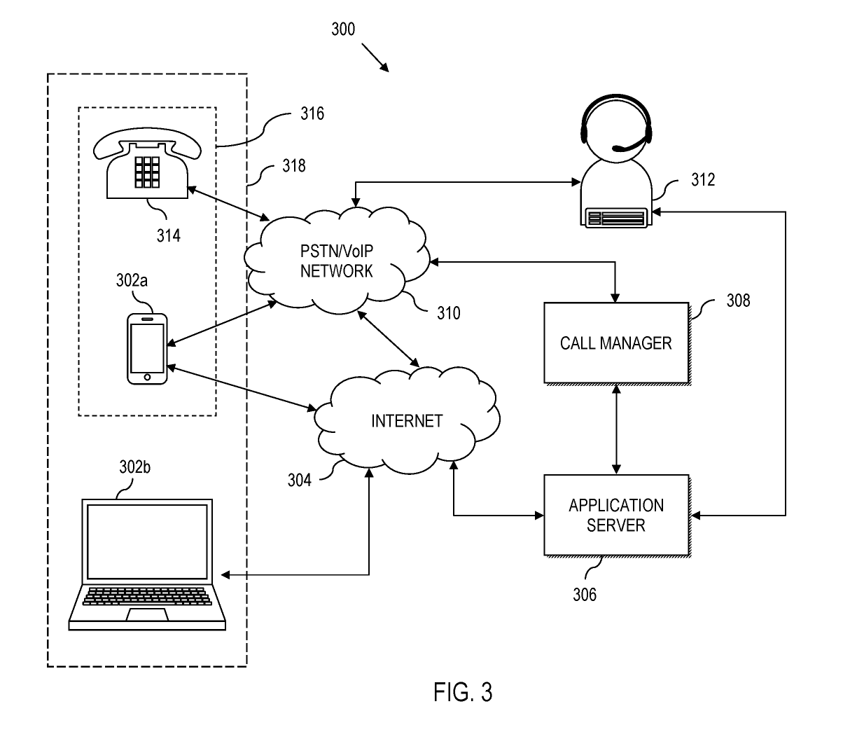

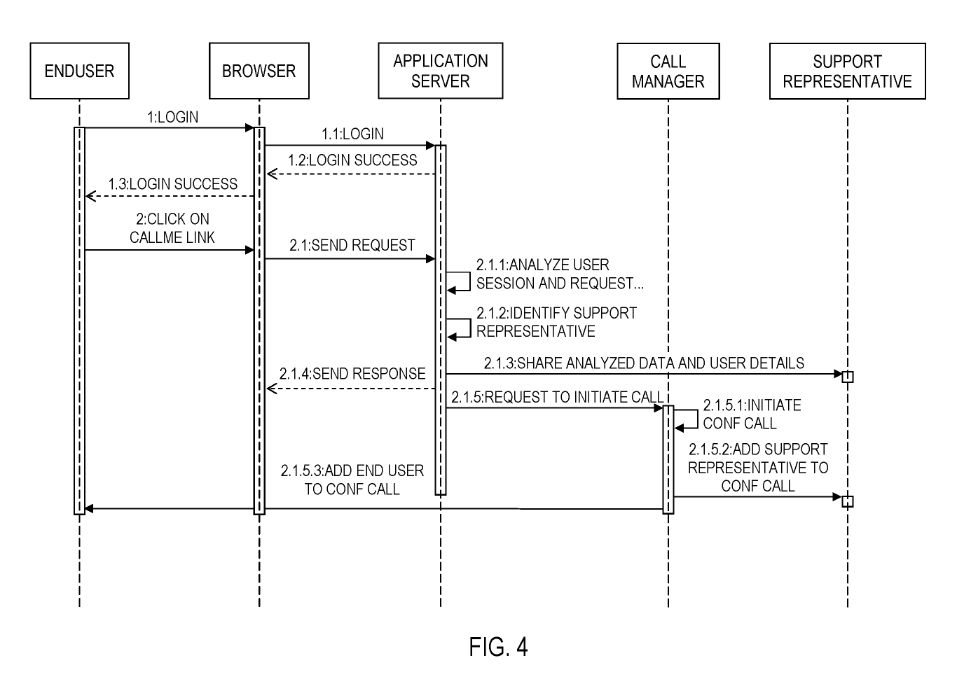

In view of the processes of FIGS. 1 and 2 reference is now drawn to FIGS. 3 and 4. Specifically, FIG. 3 is a diagram showing one embodiment of an environment 300 in which the predictive voice-based customer support of FIGS. 1 and 2 are implemented, while FIG. 4 is a process flow diagram within the context of the environment 300 of FIG. 3. Consequently, the flow of FIG. 4 is described in conjunction with the environment 300 of FIG. 3.

With reference to FIG. 3, an embodiment of the environment 300 comprises user network devices (such as a handheld device 302a or a laptop computer 302b) (collectively, 302), a data network 304 (such as the Internet), an application server 306, a call manager 308, a voice network 310 (such as a public switched telephone network (PSTN) or a voice-over-Internet protocol (VoIP) network), a customer support representative device 312, a user-accessible communication device, e.g., schematically represented by the telephone 314 or other user voice device (such as the handheld device 302a) (user communication devices, i.e., voice devices also referred to collectively as 316).

The user network devices 302 and the user voice devices 316 are located at a user location 318 (or client-side), while the customer support representative device 312, the call manager 308, and the server 306 are located at the server server-side. Also, as noted in FIG. 3, the customer support representative device 312 includes hardware and software necessary to allow interaction with both the application server 306 and hence the network 304 (either directly or via the application server 306), and the voice network 310. Although a single customer support representative device 312 is illustrated for simplicity of discussion, in practice, a call center will have numerous instances of the customer support representative device 312, each operated by an individual having domain level expertise of relevance to the call center in one or more areas of customer support.

Moreover, the application server 306 interacts with the call manager 308, e.g., an electronic device that serves as a bridge, provides processing etc., between the application server 306 and the voice network 310. The application server 306 also includes specialized software that enables interaction with the customer support representative device(s) 312, and the network 304. As such, in the context of the present disclosure, the server 306 is not a conventional server, but rather a special purpose machine operatively programmed to carry out algorithms described more fully herein, that improve the technology of call centers.

The disclosure herein thus improves the technology of data network to voice network bridging by providing efficient tools that automate the translation of electronic data extracted across a first network (data network 304) to instructions to trigger voice-based communication across a second, independent network (voice network 310), in such a way that information is uniquely gathered and presented to the customer support representative device 312 before the customer support representative device 312 call is placed to a user across the voice network 310. Moreover, the technology of data centers is improved by systems and processes that predict the nature of a user query and select an appropriate customer support representative device before the user is connected to a customer support representative associated with the selected customer support representative device.

Referring to FIG. 4, in an example process flow, an end user enters login information or login credentials onto an end user device (e.g., device 302, FIG. 3) browsing a website via a browser that is located on one of the network devices of the user (1:LOGIN). The browser forwards the login information to a server (e.g., application server 306 via the data network 304, FIG. 3) (1.1:LOGIN). The server thus receives the login credentials (e.g., 102, FIG. 1) and evaluates the login attempt and acknowledges the success or failure of the login to the browser (1.2:LOGIN). Login success or failure information is then conveyed to the end user (1.3:LOGIN). Upon establishing the user session (e.g., 104, FIG. 1), context information (e.g., the navigation history, browsing history, or other relevant discoverable information) is stored, for instance, at the server e.g., 106, FIG. 1).

While navigating through the website, if the end user wishes to speak to a customer support representative 312, then the end user selects a user-selectable feature, e.g., clicks on a user-selectable icon, such as a “call me” link, a visible hyperlink, or some other selectable indicator on the browser executing on the end user device. Interacting with the user-selectable icon results in the browser sending a request to the application server (2.1: SEND REQUEST). Upon receiving the support request (e.g., 202, FIG. 2) at the application server, the application server retrieves the context information (e.g., 204, FIG. 4) and analyzes (2.1.1:ANALYZE USER SESSION AND REQUEST) the context information (e.g., 206, FIG. 2) from the user session. From its analysis, the server eventually identifies a customer support representative (2.1.2:IDENTIFY SUPPORT REPRESENTATIVE), and selects a customer support device that the identified customer support representative has logged into. In the embodiment of FIG. 4, upon selecting the customer support representative device, the server shares the analyzed context information with the customer support representative device (2.1.3: SHARE ANALYZED DATA AND USER DETAILS). The server also sends a response to the browser (2.1.4:SEND RESPONSE) and transmits (e.g., 212, FIG. 2) a request to the electronic call manager to initiate a voice-based call between a communication device of the end user capable of voice communication, and the customer support representative device associated with the identified customer support representative (2.1.5:REQUEST TO INITIATE CALL).

Upon receiving the request, the electronic call manager 308 automatically initiates the conference call (2.1.5.1:INITIATE CALL) and adds the customer support representative device and the end user voice-capable communication device to the conference call (2.1.5.2 ADD SUPPORT REPRESENTATIVE TO CONF CALL; and 2.1.5.3:ADD END USER TO CONF CALL). Depending on whether or not the end user requested voice-based customer service from a handheld device 302a or a laptop computer 302b, the call manager 308 will add the end user via the handheld device 302a or the telephone 314 in the example environment of FIG. 3.

Again, because the context information is already provided to the customer support representative before the voice-based connection is established between the end user and the customer support representative, the embodiments of FIGS. 3 and 4 allow for fewer delays and frustrations than what end users normally experience during voice-based customer support calls.

With reference to FIGS. 1, 2, 3, and 4 generally, and according to further aspects of the present disclosure, computer-readable hardware is provided. The computer-readable hardware includes program code stored thereon. For instance, the computer-readable hardware can comprise memory that is accessible by a physical hardware processor in the application server 306 (FIG. 3). Here, the program code is executable to perform receiving, at a server computer, a support request for voice-based customer support over a digital network, from a user interacting with a client device. The program code is also executable to perform retrieving context information in response to receiving the support request. The program code is further executable to perform analyzing the retrieved context information, and predicting an anticipated voice-based customer query based on the analyzed context information. Still further, the program code is executable to perform selecting a customer support representative device based on the predicted customer query, and transmitting automatically, from the server computer to a voice communication system, a request to initiate a voice-based connection between a communication device of the user and the selected customer support representative device, hence connecting the user to an appropriate customer support representative.

In an example implementation, the computer-readable hardware includes program code that is further executable to perform receiving the support request in response to the user selecting a user-selectable link on the client device. In another example implementation, the computer-readable hardware includes program code that is further executable to perform storing a browsing history of the user prior to receiving the support request, retrieving a web browsing history of the user, analyzing a navigation sequence of visited pages in a browsing history of the user, or any combination thereof.

In yet another example implementation, the computer-readable hardware includes program code that is further executable to perform prior to receiving the support request, receiving login credentials of the user, establishing a user session at the server computer based on the received login credentials, and storing the context information during the established user session.

In still another example implementation, the computer-readable hardware includes program code that is further executable to perform looking up a predetermined list of entries corresponding to customer needs, and matching a navigation sequence of a browsing history to an entry in the predetermined list corresponding to a predicted customer need.

In still another example implementation, the computer-readable hardware includes program code that is executable to perform any capability, feature or function (or combinations thereof) described more fully herein with reference to FIG. 1-FIG. 4.

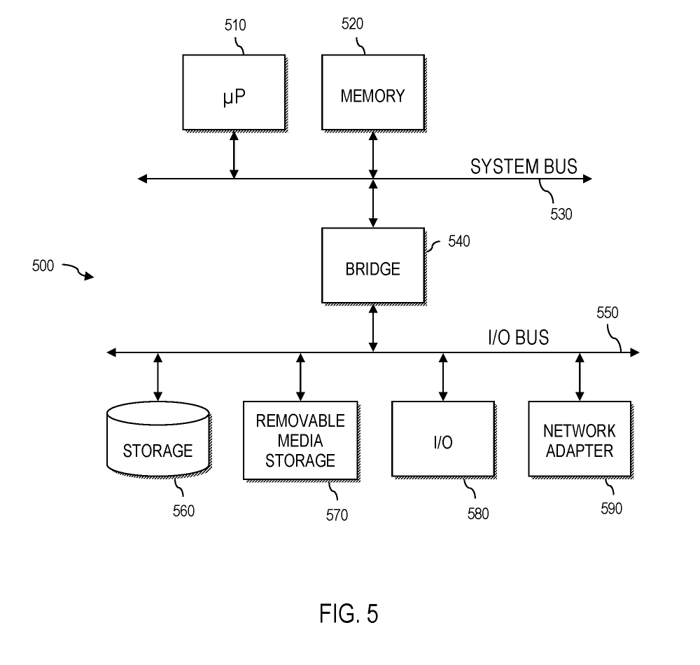

With reference to FIG. 5 a schematic diagram of a computer system 500 illustrates computer readable program code for executing the processes described herein. For some embodiments, FIG. 5 shows an example, among others, of a computer system 500 by which one or more of the application server 306, the handheld device 302a, the laptop computer 302b, and the call manager 308 is implemented. The computer system 500 includes one or more microprocessors 510 that are connected to memory 520 via a system bus 530. A bridge 540 connects the system bus 530 to an input-output (I/O) bus 550 that links peripheral devices to the microprocessor(s) 510. Peripherals may include storage 560, such as a hard drive, removable media storage 570, e.g., tape drive, floppy, flash, CD and/or DVD drive, I/O device(s) 580 such as a keyboard, mouse, etc., and a network adapter 590. In this regard, the microprocessor(s) 510 may thus read computer instructions stored in the memory 520, storage 560, removable media storage 570, or combinations thereof, to implement one or more of the aspects, as set out in greater detail herein.

Using the computer system 500 as one example of the server 306 that implements the process 200, the server 306 comprises a receiver communicatively coupled to a digital network (shown as network adapter 590), the receiver configured to receive a support request for voice-based customer support over the digital network. Moreover, the receiver receives (202, FIG. 2) the support request from the user device.

The server also comprises a transmitter (also shown as the network adapter 590), communicatively coupled to a voice communication system, the transmitter configured to transmit the generated request to the voice communication system. The transmitter transmits (212, FIG. 2), the request to initiate the voice-based connection between the user and the customer support representative 312. The server further comprises computer-readable hardware memory (shown as either memory 520, storage 560, or removable media storage 570) on which the server stores the context information (106, FIG. 1), and from which the server retrieves the context information. For some embodiments, the memory 520, 560, or 570, comprises the predetermined list of entries corresponding to predicted customer needs.

In additional embodiments, the memory 520, 560, 570, or a combination thereof, stores program code that programs the processor(s) 510 to retrieve the context information (e.g., 204, FIG. 2) from the computer-readable hardware memory in response to the received support request, analyze the retrieved context information (e.g., 206, FIG. 2), predict an anticipated voice-based customer query based on the analyzed context information (e.g., 208, FIG. 2), select a customer support representative device based on the predicted customer query (210, FIG. 2), and generate a request to initiate a voice-based connection between a communication device of the user device and the selected customer support representative device (e.g., 212, FIG. 2), as described more fully herein, e.g., with reference to FIGS. 1 and 2.

In certain embodiments where the computer-readable hardware memory further comprises login credentials of a user, the processor 510 is further programmed to receive a login request from the user, authenticate the login request using the login credentials, and establish a user session in response upon authenticating the login request.

The processor 510, in some embodiments, is further programmed to write the context information to the computer-readable hardware memory during the established user session, the context information comprising a browsing history.

Where the computer-readable hardware memory further comprises a predetermined list of entries corresponding to customer needs, the processor can be further programmed to match a navigation sequence of the browsing history to an entry in the predetermined list corresponding to a predicted customer need. The processor may also be programmed to match the retrieved context information with an entry corresponding to a predicted customer need in the predetermined list and select the customer support representative device based on the entry associated with the predicted customer need that matched with the context information.

The processor 510, in further embodiments, is programmed with a means for matching the retrieved context information with a customer need. For instance, in an example implementation, the storage 560 stores a database that comprises the predetermined list of entries. Each entry corresponds to a predicted need of the user or other information as set out in greater detail herein. The storage 560 also stores the context information collected from a user device during a user session (and/or previous user session(s)) as set out in greater detail herein. The microprocessor 510 executes program code stored in memory 520 that implements a matching algorithm that matches the context information to an entry(ies) in the predetermined list, also as described more fully herein.

The processor 510, in some embodiments, is programmed with a means for selecting the customer support representative device based on the customer need matched with the context information. For instance, in an example implementation, the storage 560 stores a database that comprises data indicative of customer support representative identities, capabilities, expertise, measures, availability, etc., in addition to the above-noted features described with reference to the means for matching. The microprocessor 510 executes program code stored in memory 520 that implements a selection algorithm that selects the customer support representative device based upon the previously matched context information to the entry(ies) in the predetermined list, also as described more fully herein.

The processor 510, in some embodiments, is further programmed to perform the various other functions as described above.

Aspects of the present disclosure may be illustrated and described herein in any of a number of patentable classes or context including any new and useful process, machine, manufacture, or any new and useful improvement thereof. Accordingly, for some embodiments, aspects of the present disclosure are implemented entirely in hardware, entirely in software (including firmware, resident software, micro-code, etc.) or combining software and hardware implementation that are generally referred to herein as a “circuit,” “module,” “component,” “system,” or various combinations thereof. Furthermore, for other embodiments, aspects of the present disclosure take the form of a computer program product embodied in one or more computer readable media having computer readable program code embodied thereon.

For yet other embodiments, any combination of one or more computer readable media are utilized. The computer readable media, for some embodiments, comprise a computer readable signal medium or a computer readable storage medium. A computer readable storage medium is, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus, or device.

A computer readable signal medium includes a propagated data signal with computer readable program code embodied therein, for example, in baseband or as part of a carrier wave. Depending on the implementation, such a propagated signal takes any of a variety of forms, including, but not limited to, electro-magnetic signal, optical signal, or any suitable combination thereof. A computer readable signal medium is specifically not a computer readable storage medium. Likewise, a computer readable storage medium is specifically not a computer readable signal medium.

In some embodiments, computer program code for carrying out operations for aspects of the present disclosure is written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. Depending on the embodiment, the program code executes entirely on the user's computer, partly on the user's computer, as a stand-alone software package, partly on the user's computer and partly on a remote computer or entirely on the remote computer or server. In the latter scenario, the remote computer is connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, is implemented by computer program instructions for some embodiments. These computer program instructions are provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

In yet other embodiments, these computer program instructions are stored in a computer readable medium that when executed direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions, for some embodiments, are loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the drawings illustrate the architecture, functionality, and operation of possible implementations of systems, methods and computer program products according to various aspects of the present disclosure. In this regard, for some embodiments, each block in the flowchart or block diagrams represents a module, segment, or portion of code, which comprises one or more executable instructions for implementing the specified logical function(s). It should also be noted that, in some alternative implementations, the functions noted in the block occur out of the order noted in the drawings. For example, unless otherwise expressly noted or discernible by context, two blocks shown in succession are, for some embodiments, executed substantially concurrently, or the blocks are sometimes executed in reverse order, depending upon the functionality involved. It will also be noted that each block of the block diagrams and/or flowchart illustration, and combinations of blocks in the block diagrams and/or flowchart illustration, are implemented in some embodiments by special purpose hardware-based systems that perform the specified functions or acts, or combinations of special purpose hardware and computer instructions.

For clarity, and by way of example, which is not intended to limit the scope of this disclosure, the structures and functions associated with the receiver are implemented using one or more of the hardware (e.g., the network adapter 590 of FIG. 5), software, or combinations of hardware and software as recited herein. Similarly, the structures and functions associated with transmitter are implemented using one or more of the hardware (e.g., network adapter 590), software, or combinations of hardware and software as recited herein. Also, the structures and functions associated with computer-readable hardware memory are implemented using one or more of the hardware (e.g., memory 520, storage 560, removable media storage 570, or combinations thereof, as shown and described with reference to FIG. 5), software, or combinations of hardware and software as recited herein.

Additionally, the structures and functions associated with the processor are implemented using one or more of the hardware (e.g., microprocessor 510 of FIG. 5), software, or combinations of hardware and software as recited herein. Furthermore, the means for performing various functions (e.g., means for matching, means for selecting, etc.) are shown as hardware components, software components, or combinations of hardware and software components as recited herein.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A computer-implemented process comprising:
receiving login credentials of a user;
establishing a user session at a server computer, the user session being established based on the received login credentials;
storing context information during the established user session;
receiving, at the server computer, a support request for voice-based customer support over a digital network, from the user interacting with a client device;
retrieving the context information in response to receiving the support request, wherein retrieving the context information includes at least one of: retrieving a browsing history of the user, retrieving logged in user information, and retrieving web form data;
analyzing the retrieved context information by analyzing at least one of:
analyzing at least one navigation sequence of visited pages in the browsing history of the user;
analyzing at least one request parameter, analyzing a user's transaction history; and
analyzing at least one response and/or error code;
predicting an anticipated voice-based customer query based on the analyzed context information;
selecting a customer support representative device based on the predicted customer query; and
transmitting automatically, from the server computer to a voice communication system, a request to initiate a voice-based connection between a communication device of the user and the selected customer support representative device.

2. The computer-implemented process of claim 1, wherein receiving, at the server computer, the support request for the voice-based customer support over the digital network comprises:
receiving the support request in response to the user selecting a user-selectable link on the client device.

3-5. (canceled)

6. The computer-implemented process of claim 5, wherein storing the context information comprises:
storing a browsing history of the user.

7. The computer-implemented process of claim 6, wherein predicting an anticipated voice-based customer query comprises performing at least one of:
looking up a predetermined list containing entries corresponding to customer needs;
determining the anticipated voice-based customer query based upon a request uniform resource locator pattern;
determining the anticipated voice-based customer query based upon a response code; and
determining the anticipated voice-based customer query based upon a functionality mapping; and
matching at least one of:
a navigation sequence of visited pages in the browsing history of the user, at least one request parameter;
a user's transaction history; and
at least one response and/or error code,
to an entry associated with a predicted customer need in the predetermined list.

8. A server computer comprising:
a receiver communicatively coupled to a digital network, the receiver configured to receive a support request for voice-based customer support over the digital network;
a computer-readable hardware memory comprising context information concerning an established user session of a user;
a processor programmed to:
receive login credentials of the user;
establish the user session at a server computer, the user session being established based on the received login credentials;
storing context information during the established user session;
retrieve the context information from the computer-readable hardware memory in response to the received support request, wherein retrieving the context information includes at least one of: retrieving a browsing history of the user, retrieving logged in user information, and retrieving web form data;
analyze the retrieved context information by analyzing at least one of:
analyzing at least one navigation sequence of visited pages in the browsing history of the user;
analyzing at least one request parameter, analyzing a user's transaction history; and
analyzing at least one response and/or error code;
predict an anticipated voice-based customer query based on the analyzed context information;
select a customer support representative device based on the predicted customer query; and
generate a request to initiate a voice-based connection between a communication device of the user and the selected customer support representative device; and
a transmitter communicatively coupled to a voice communication system, the transmitter configured to transmit the generated request to the voice communication system.

9. (canceled)

10. The server computer of claim 9, wherein the processor is further programmed to write the context information on the computer-readable hardware memory during the established user session, the context information comprising a browsing history.

11. The server computer of claim 10, wherein the computer-readable hardware memory further comprises a predetermined list of entries corresponding to customer needs, and wherein the processor is further programmed to match a navigation sequence of the browsing history to an entry associated with a predicted customer need.

12. The server computer of claim 8, wherein the computer-readable hardware memory further comprises a predetermined list of entries associated with customer needs, and wherein the processor is further programmed to:
match the retrieved context information with an entry associated with a predicted customer need in the predetermined list; and
select the customer support representative device based on the entry associated with the predicted customer need matched with the context information.

13. The server computer of claim 8, further comprising:
means for matching the retrieved context information with a customer need; and
means for selecting the customer support representative device based on the customer need matched with the context information.

14. Computer-readable hardware with program code stored thereon, wherein the program code is executable to perform:
receiving, at a server computer, a support request for voice-based customer support over a digital network, from a user interacting with a client device;
receiving login credentials of the user;
establishing a user session at a server computer, the user session being established based on the received login credentials;
storing context information during the established user session;
receiving, at the server computer, a support request for voice-based customer support over a digital network, from the user interacting with a client device;
retrieving the context information in response to receiving the support request, wherein retrieving context information includes at least one of: retrieving a browsing history of the user, retrieving logged in user information, and retrieving web form data;
analyzing the retrieved context information by analyzing at least one of:
analyzing at least one navigation sequence of visited pages in the browsing history of the user;
analyzing at least one request parameter, analyzing a user's transaction history; and
analyzing at least one response and/or error code;
predicting an anticipated voice-based customer query based on the analyzed context information;
selecting a customer support representative device based on the predicted customer query; and
transmitting automatically, from the server computer to a voice communication system, a request to initiate a voice-based connection between a communication device of the user and the selected customer support representative device.

15. The computer-readable hardware of claim 14, wherein the program code is further executable to perform:
receiving the support request in response to the user selecting a user-selectable link on the client device.

16-18. (canceled)

19. The computer-readable hardware of claim 14, wherein the program code is further executable to perform:
storing a browsing history of the user prior to receiving the support request.

20. The computer-readable hardware of claim 14, wherein the program code is further executable to perform:
looking up a predetermined list of entries corresponding to customer needs; and
matching a navigation sequence of a browsing history to an entry of the predetermined list corresponding to a predicted customer need.
